(19) United States
(12) Patent Application Publication
(10) Pub. No.: US 2019/0096191 A1
(43) Pub. Date: Mar. 28, 2019

(54) Combination Wagering Game

(71) Applicants: Joseph Stuehling, Las Vegas, NV (US); Brian Rainone, Las Vegas, NV (US)

(72) Inventors: Joseph Stuehling, Las Vegas, NV (US); Brian Rainone, Las Vegas, NV (US)

(21) Appl. No.: 16/138,533

(22) Filed: Sep. 21, 2018

Related U.S. Application Data
(60) Provisional application No. 62/562,213, filed on Sep. 22, 2017.

(51) Int. Cl. G07F 17/32

(52) U.S. Cl. CPC G07F 17/3293; G07F 17/322; G07F 17/3258; G07F 17/3267

(57) ABSTRACT

A method of playing a casino-style combination wagering game with at least one deck of standard playing cards comprising the steps of: Each player making two wagers on an individual playing and wagering area, one wager a 21 wager, and the other a poker-type wager; each player placing an optional bonus wager as a side wager; a dealer dealing at least two cards to each player, the first two cards being face up; the dealer dealing his or herself two cards, one of the cards being face down; playing the games of 21, a poker-like game, and a bonus game; and resolving the wagers for each game according to basic or modified rules of blackjack, poker and a specialized bonus game. The combination wagering game may be implemented on a custom casino playing and wagering surface, an electronic gaming machine or on a networked electronic gaming machine.

### CROSS- REFERENCE TO RELATED APPLICATIONS

The present utility patent application claims priority benefit of the U.S. provisional application for patent serial number 62/562,213 titled “Combination Wagering Game” filed on Sep. 22, 2017 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates generally to the field of casino wagering games. More specifically, the present invention relates to combination blackjack and poker variant card games.

### 2. Description of the Related Art

Blackjack, also known as 21, is arguably one of the most popular casino table games. Its popularity is largely due to the simplicity of the game, the speed of play, and relatively small house advantage. From its unknown beginnings in medieval Europe to the vibrant casinos of today, the rules and concepts have remained very much the same.

In its traditional form, blackjack is played at a gaming table using standard physical playing cards. It is well known that blackjack is grounded in simple concepts and procedures which are easily learned and understood by casual and regular players alike. The game allows players to employ simple playing and wagering strategies that provide a certain degree of control. Because of this simplicity, the game requires relatively low overhead for casino operators to implement and operate.

In blackjack, at its most basic form, players are each dealt two cards, face up or down depending on house rules. The dealer is also dealt two cards, normally one up (exposed) and one down (hidden). The value of cards two through ten is their numeric value (2 through 10), whereas face cards (Jack, Queen, and King) are all worth ten. Aces can be worth one or eleven. A blackjack hand's value is the sum of its card values. Players are allowed to draw additional cards to improve their hands. Once the players have completed their hands, the dealer then draws cards generally until the dealer's numerical hand value totals 17 or more without exceeding 21. The object of the game is to beat the dealer by obtaining a numerical value of 21 on the player's first two cards, reaching a final score higher than the dealer without exceeding a numerical value exceeding 21 or letting the dealer draw additional cards until the dealer's hand exceeds a numerical value of 21.

In recent years, though, the world of casino gaming has expanded and become more much more competitive. In response to increased demand for newer and more exciting games, casinos have attempted to offer patrons a greater variety of table games. In response to the aforementioned demand, a number of blackjack hybrid games have been developed which combine the elements of blackjack with other card or dice games. These new games add extra dimensions and extra challenges to standard blackj ack.

Poker is also a highly popular family of casino card games which combine gambling, strategy and a degree of skill. Poker generally involves an initial wager, known as an ante, with additional wagers made as a hand is dealt. The object of poker is to obtain a hand which is ranked higher in a hierarchical system which ranges from the highest numerical card value to groups of equally numbered cards, to groups of cards belonging to the same suite (i.e. clubs, spades, hearts and diamonds), to a sequentially ranked hand, all of the same suit. Certain poker games are played against other players while other kinds of poker games are played against a dealer.

In response to the demand for newer and more exciting games, simpler versions of poker have been developed to mimic traditional poker and incorporate the speed and flow of regular casino table games. One such game is three card poker. In three card poker, players attempt to obtain higher ranked hands than the dealer. The general rules involve players making an initial wager (an ante and a pair plus, which can be played optionally), cards are dealt, players determine whether they have a playable hand, players then can wager again on a playable hand, and then winning hands are paid according to initial wager and bonus wager options. Numerous other poker-type variants have been developed as well.

The growth in slot machine, video poker, smartphone applications (also known as apps) and other online gaming popularity has also created a greater demand for computer-implemented video games mimicking the casino table gaming experience. In response to such demand, most casinos offer video gaming machines which simulate in varying degrees a number of casino table games. Additionally, online gaming has also attempted to offer a number of internet-enabled games which simulate casino table games in varying degrees. Moreover, the growth in smartphone app popularity has led casinos and gaming companies alike to develop new games and new gaming applications designed to mimic the casino gaming experience.

Because both blackjack and poker are relatively simple to learn and employ basic wagering and playing strategies, a demand exists for new and interesting combinations and variants of these two classic games. And despite numerous variants and combinations that are currently available, there still exists a need to provide for new table gaming experiences on the casino floor which combines elements of blackjack and poker, which also contain a bonus or jackpot feature. There also exists the need for a casino gaming machine which implements new blackjack variant games which combine the elements of blackjack and poker which contains a bonus or jackpot feature. Moreover, there still exists a need for internet-enabled casino wagering games which combine the elements of blackjack and poker which contains a bonus or jackpot feature.

### SUMMARY

The object of the present invention is to provide an advanced casino wagering game that combines elements of blackjack and poker, which contains an optional bonus or jackpot feature. The present invention is directed towards a combination wagering game which can be implemented as, but not limited to, a standard casino table game, an electronic gaming machine, a smartphone application, or as an internet enabled casino-style wagering game.

The exemplary combination wagering game is, at its essence, a wagering game which combines elements of traditional blackjack, also known as 21, and basic poker with one or more bonus features. In a casino embodiment, the invention can be played in conjunction with a custom casino-type table and a single deck of standard playing cards or multiple-deck “shoe” or shuffle machine containing multiple standard decks of 52 playing cards, or through the use of specialized decks of cards containing specially designed cards. The custom casino table surface has mandatory wagering areas for both a 21 wager and a poker-type wager. In addition to the two mandatory wagering areas, at least one optional bonus or jackpot wagering area exists. In such an embodiment, the table displays gaming areas, card areas, payout scales, and further instructional and promotional information. The game, in general, flows by each player making two wagers on an individual playing and wagering area (one wager a 21 wager, and the other a poker-type wager), each player placing an optional bonus wager as a side wager, the dealer dealing at least two cards to each player (the first two cards being face up), the dealer dealing his or herself two cards (one of the cards being face down), playing the games of 21, a poker-like game, and a bonus game, and then resolving the wagers for each game according to basic or modified rules of blackjack, poker and a specialized bonus game.

The object of the exemplary combination wagering game is to beat the dealer by making the best 21 hand possible while also improving a poker-type hand with the same cards. Unlike standard blackjack, the rules of the present invention do not provide for insurance. Also unlike standard blackjack, jacks have no numerical value in the 21 element of the game. Additionally, there is no “splitting” of equal ranked cards. Furthermore, there is no “doubling down” feature. Moreover, the payoff value for a natural blackjack is two to one. The poker-type hand will be the best of up to three cards and may take on special values, or implement trade names such as the TripleJack hand.

The game begins by players placing two mandatory wagers—one for the 21 hand, and one for a poker-type hand known in the preferred embodiment of the invention as the TripleJack hand. Players also have an option to place an additional side wager which is directed to a set of specifically ranked hands. Once the bets are placed, the hands are dealt. Each player gets a turn to improve their hand by drawing cards until they are satisfied with their hand, draw three Jacks, draw to a numerical value of hard 21 (hard 21 being a hand value of 21 with three or more cards) or “bust” by their 21 hand exceeding the numerical rank of 21. When all players have finished improving their hands or “busting,” the dealer draws the house hand based on set rules which are essentially the same as standard blackjack. The preferred embodiment of the invention differs from standard blackjack in that one of the objects is to obtain three jacks, which is a higher ranked hand than blackjack or 21, and is also a ranked poker hand in the TripleJack feature. Once the dealer's hand is played, each player's hand is compared to the dealer's. If the player's hands for each corresponding wager are greater than that of the dealer's, then wagers are paid out according to specific pay rules.

In the present invention, mathematical probability principles dictate that as the number of decks increases, the probability of obtaining different hand ranks varies. For example, with an increasing number of decks, the relative probability of drawing straight flush and a straight draws decreases, whereas the relative probability of drawing three of a kind, flush and pair draws increases, while the overall frequency of a pair or better also increases. With the use of multiple decks, the player may ultimately draw hands of suited triples such as three sevens of diamonds or three jacks of spades. Such mathematical probabilities decrease with increasing numbers of decks, and offers casinos the use of multiple decks of cards to provide a jackpot pay scale or even a progressive jackpot. Furthermore, the use of multiple decks of cards enable gaming establishments to use special cards in a multi-deck shoe or shuffling machine to further increase the odds of drawing those three special cards. In addition to the potential for employing multiple numbers of card decks, the present invention further allows for the use of specialized cards which may be added to traditional card decks to create even higher ranking hands with higher payout odds.

The present invention can be readily implemented across a wide variety of forms and media including, but not limited to, single player video slot machines, multi-player video slot machines, electronic games and devices, lottery terminals, scratch-card formats, travel consoles, and home and internet gaming. As a software implementation, multiple different combinations using different numbers of decks of cards and specialty cards added to those decks are contemplated as within the scope of this invention. Additionally, the present invention can be readily implemented across a wide variety of networked or non-networked mobile technologies such as, but not limited to, smartphone applications and wearable technology devices such as smart watches. Moreover, the invention can be readily implemented in software, which can be stored on a readable medium (e.g., flash memory, hard disk, cloud storage, or compact disc (CD), etc.) and used with a computer system.

### BRIEF DESCRIPTION OF THE DRAWINGS

The invention directed by way of example, and not by way of limitation, in the figures of the accompanying drawings and in which like reference numerals refer to similar elements and in which:

FIG. 1 illustrates an exemplary custom casino playing surface or layout in accordance with an embodiment of the invention;

FIG. 2 illustrates an expanded view of an individual playing and wagering area in accordance with an embodiment of the invention;

FIG. 3A illustrates a flow diagram of the overall process of playing a casino wagering game as described in accordance with an embodiment of the invention.

FIG. 3B illustrates a flow diagram of the process of playing the exemplary combination wagering game as described in accordance with an embodiment of the invention.

FIG. 3C further illustrates a flow chart of the process of playing a combination wagering game as described in accordance with an embodiment of the invention.

FIG. 3D further illustrates a flow chart of the process of playing a combination wagering game as described in accordance with an embodiment of the invention.

FIG. 3E further illustrates a flow chart of the process of playing a combination wagering game as described in accordance with an embodiment of the invention.

FIG. 4 illustrates a view of an exemplary playing and wagering surface or layout with player and dealers cards shown as example hands in accordance with an embodiment of the invention.

FIG. 5A illustrates a perspective view of a gaming machine employing a combination wagering game in accordance with an embodiment of the invention.

FIG. 5B illustrates a screen display of a combination wagering game in accordance with an embodiment of the invention.

FIG. 6 illustrates a computer system that, when appropriately configured or designed, may serve as a computer system or electronic gaming machine (EGM) for which the combination wagering game may be embodied.

FIG. 7 illustrates a block diagram depicting a conventional client/server communication system.

FIG. 8 illustrates a block diagram representing a simple blockchain.

FIG. 9 illustrates a block diagram representing details of each block and transaction in the blockchain of FIG. 8.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “one variant,” “an embodiment,” “a variant,” “various embodiments,” “numerous variants,” etc., may indicate that the embodiment(s) of the invention so described may include particular features, structures, or characteristics. However, not every embodiment or variant necessarily includes the particular features, structures, or characteristics. Further, repeated use of the phrase “in one embodiment,” or “in an exemplary embodiment,” or “a variant,” or “another variant,” do not necessarily refer to the same embodiment although they may. A description of an embodiment with several components in communication with each other does not imply that all such components are required. On the contrary, a variety of optional components are described to illustrate the wide variety of possible embodiments and/or variants of the present invention.

A “computer” may refer to one or more apparatus and/or one or more systems that are capable of accepting a structured input, processing the structured input according to prescribed rules, and producing results of the processing as output. Examples of a computer may include: a personal computer (PC); a stationary and/or portable computer; a computer having a single processor, a computer having multiple processors, or a computer having multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer; a personal digital assistant (PDA); a portable telephone; a portable smartphone; wearable devices such as smartwatches; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

“Software” may refer to prescribed rules and/or instructions used to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium employing software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a plurality of computers and associated devices that may be connected by communication channels to facilitate communication and resource sharing. A network may involve permanent connections such as cables or temporary connections such as those made through telephone, cable, wireless or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include, but are not limited to, an internet, such as the Internet or World Wide Web; an intranet; a local area network (LAN); a wide area network (WAN); a virtual private network (VPN); a peer-to-peer (P2P) network; Blockchain; and a combination of networks, such as an internet and an intranet. Exemplary networks may operate with any of a number of protocols, such as Transmission Control Protocol (TCP), Internet protocol (IP), Internet Address Protocol (IP Address), asynchronous transfer mode (ATM), and/or synchronous optical network (SONET), user datagram protocol (UDP), IEEE 802.x, etc.

“Blockchain” refers to a system in which a record of transactions made on a block chain such as, but not limited to, Bitcoin and Etherium are maintained across several computers that are linked in a peer-to-peer or other network.

“Cryptocurrency” (or crypto currency) is a digital asset designed to work as a medium of exchange that uses strong cryptography to secure financial transactions, control the creation of additional units, and verify the transfer of assets. Cryptocurrencies are a kind of alternative currency and digital currency (of which virtual currency is a subset). Cryptocurrencies use decentralized control as opposed to centralized digital currency and central banking systems. The decentralized control of each cryptocurrency works through distributed ledger technology, typically a blockchain, that serves as a public financial transaction database. Exemplary cryptocurrency platforms and/or protocols include, but are not limited to, Bitcoin, Ethereum, Ripple Consensus Network, Hyperledger, R3's Corda, and Symbiont Distributed Ledger.

“Video” may refer to motion pictures represented in analog and/or digital form. Examples of video may include television, movies, image sequences from a camera or other observer, and computer-generated image sequences. Video may be obtained from, for example, a live feed, a storage device, an IEEE 1394-based interface, a video digitizer, a computer graphics engine, or a network connection.

An “Electronic Gaming Machine,” abbreviated “EGM,” refers to a modern video gaming machine used by casinos, arcades and numerous entertainment establishments worldwide. An EGM, defined broadly, is an electronic platform on which electronic games are played. As such, an EGM may also include, but is limited to, general-purpose shared and personal computers, arcade consoles, video consoles connected to home television sets, hand held game machines including smartphones, tablets, mobile telephone systems and wearable technologies such as smart watches.

Embodiments of the present invention may include more than one apparatus for performing the operations disclosed herein. An apparatus may be specially constructed for the desired purposes, or it may comprise one or more general-purpose devices selectively activated or reconfigured by a program stored in the device. Moreover, embodiments of the present invention may employ differing numbers of playing cards through the use of varying numbers of standard card decks and through the use of the addition of specially made cards added to the standard playing cards.

Embodiments of the invention may also be implemented in, or in a combination of, hardware, firmware, and software. Such embodiments may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

Unless specifically stated otherwise, and as may be apparent from the following description and claims, it should be understood that throughout this application's specification, descriptions utilizing terms such as “processing,” “computing,” “calculating,” “determining,” or the like, refer to the actions and/or processes of a computer, computing system, or any similar electronic computing device which manipulates and/or transforms data represented as physical quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. The term “microprocessor” may be used interchangeably with “processor.” A “computing platform” may comprise one or more processors.

A “non-transitory computer readable medium” includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

Aspects of the exemplary combination wagering game will be described below with reference to flowchart illustrations and/or block diagrams of methods, steps, apparatus (systems) and computer program products according to embodiments of the invention. Persons skilled in the art will understand that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the exemplary casino wagering game. It will become readily apparent to persons skilled in the art that each block in the flowchart or block diagrams may represent a module, segment, or portion of code, which comprises one or more executable instructions for implementing the specified logical function(s). It will also be readily apparent to persons skilled in the art that in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any practical order.

It will also be understood by persons skilled in the art that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It will be readily understood by persons skilled in the art that the various methods and algorithms described herein may be implemented by appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent to persons having skill in the art that more than one device or article or/machine (whether or not they cooperate) may be used in place of a single device or article or machine. Similarly, where more than one device or article or machine is described herein (whether or not they cooperate), it will be readily apparent that a single device/article may be used in place of the more than one device or article. Likewise, the functionality and/or the features of a device or article or machine may be alternatively embodied by one or more other devices or articles or machines which are not explicitly described as having such functionality and/or features. Thus, other embodiments of the present invention need not include a specific device in and of itself.

As is well known to those skilled in the art, many careful considerations and compromises typically must be made when designing the optimal manufacture or commercial implementation of such a combination wagering game. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

Systems will be described and provided with means and methods for providing and implementing a combination wagering game. The exemplary combination wagering game will now be described in detail with reference to embodiments thereof as illustrated in the accompanying drawings.

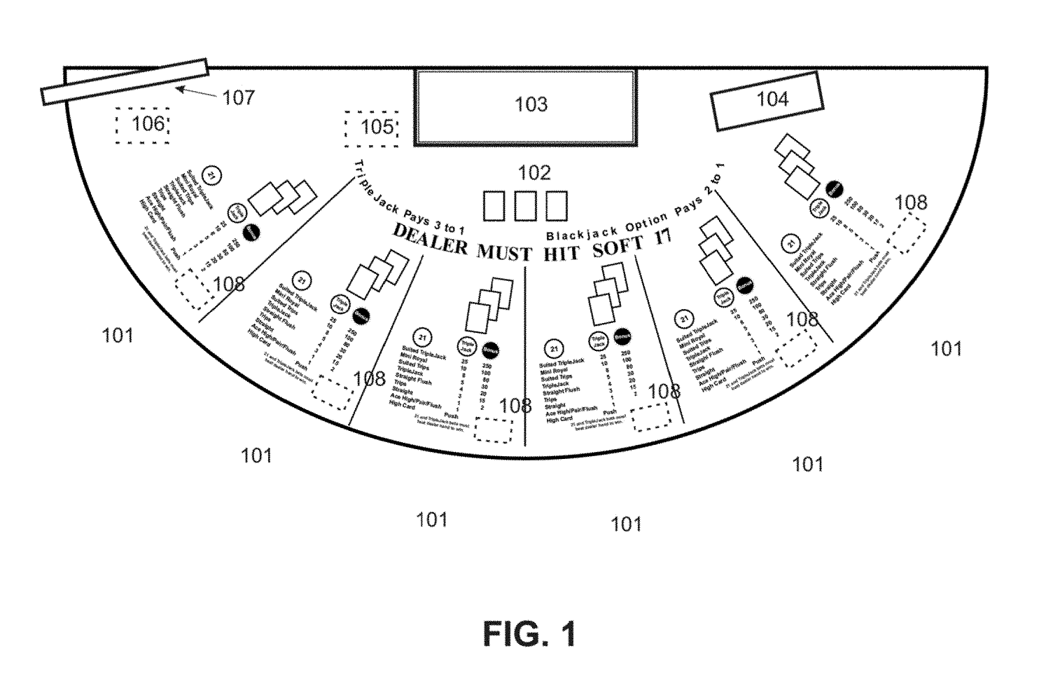

FIG. 1 illustrates a custom casino playing and wagering surface employed by an embodiment of the present invention. In one embodiment of the invention, the gaming and wagering surface is situated atop of a standard semielliptical-shaped casino gaming table such as a standard blackjack table. Like a standard blackjack gaming surface, stations for a dealer and up to six players are provided. Each player is provided an individual playing and wagering area 101. The dealer is also provided a playing area 102 a chip rack 103. The playing and wagering surface has an area for a playing card shoe and/or automatic shuffling machine 104. The playing and wagering surface may also contain an electronic interface 105 comprised of a plurality of electronic sensors, optical sensors, manual inputs connected to a microprocessor unit 106 and an external display 107. Such an interface, microprocessor and external display could be used for numerous features such as, but not limited to, displaying hands to individuals not seated at the gaming table. Such an interface, microprocessor and external display could also be used for progressive jackpot features and bonus features. Also contemplated as within the scope of the present invention are interactive features of the playing and wagering surface such as a gaming interface with varying player game controls 108 at each player's individual playing and wagering area 101. Such a gaming surface could be implemented in numerous and varying software applications for computers, electronic gaming machines (EGMs), smartphones, tablets, and wearable technologies.

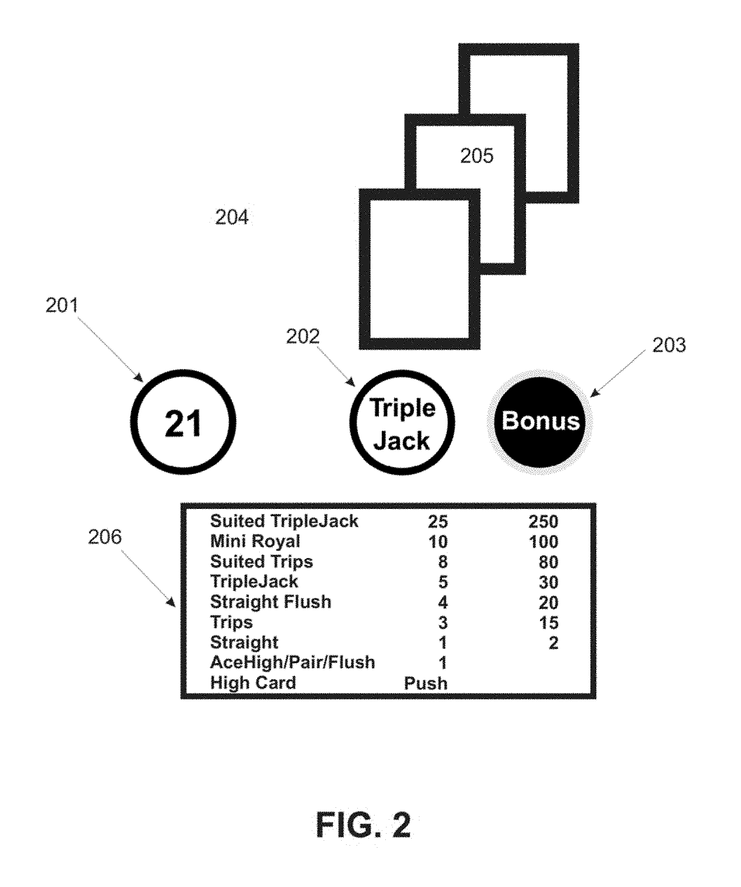

FIG. 2 illustrates an expanded view of an individual playing and wagering area employed by an embodiment of the present invention. In the preferred embodiment of the invention, each player must place a 21 wager at betting area 201 and a poker-type wager, also known as the TripleJack wager, in each marked betting area 202. Additionally, each player has the option of placing a bonus wager in the marked betting area 203. Additional wagers and wagering features may be practiced with the invention. Once wagers are made, cards are dealt to each player's respective gaming area 204. A separate place 205 for jacks, or other specialty cards, to be set aside is also provided. Payout tables 206 are provided for players to explore options and employ strategies. Pay tables may vary according to differing embodiments of the invention and differing house rules. Such an individual playing and wagering area could be implemented in numerous and varying software applications for computers, networked computers, electronic gaming machines (EGMs), smartphones, tablets, and wearable technologies.

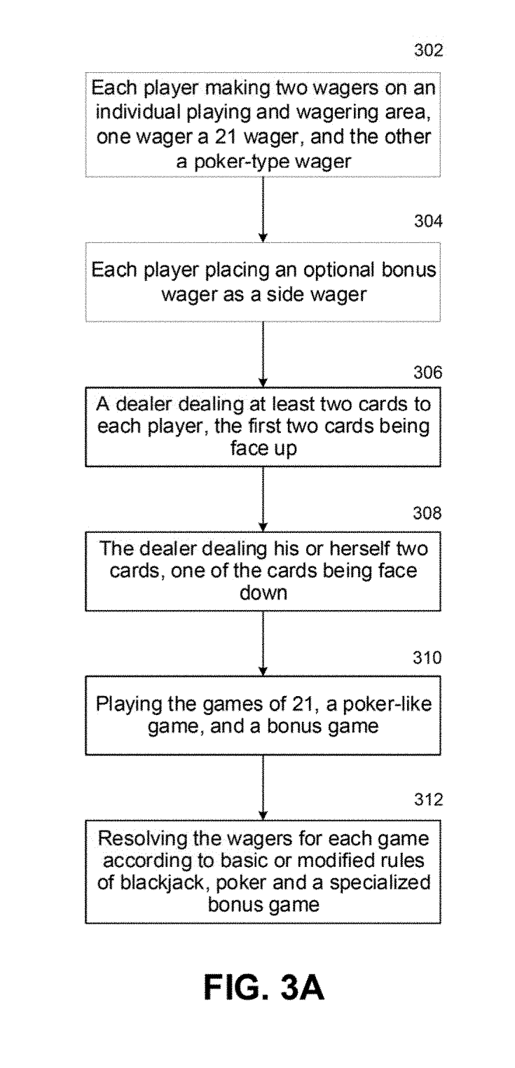

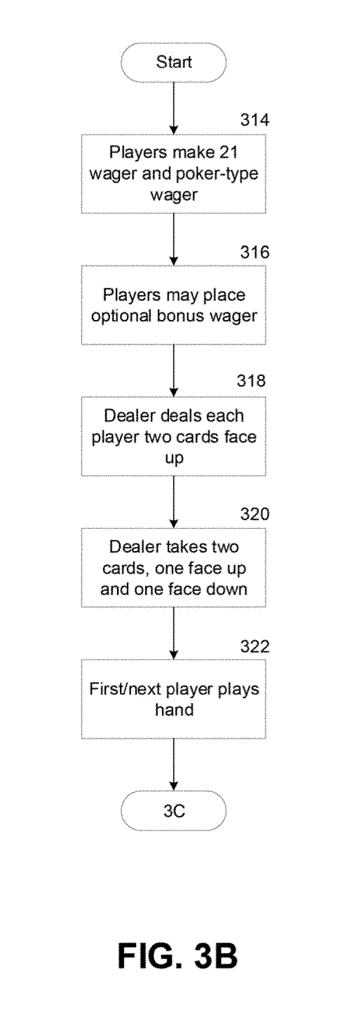

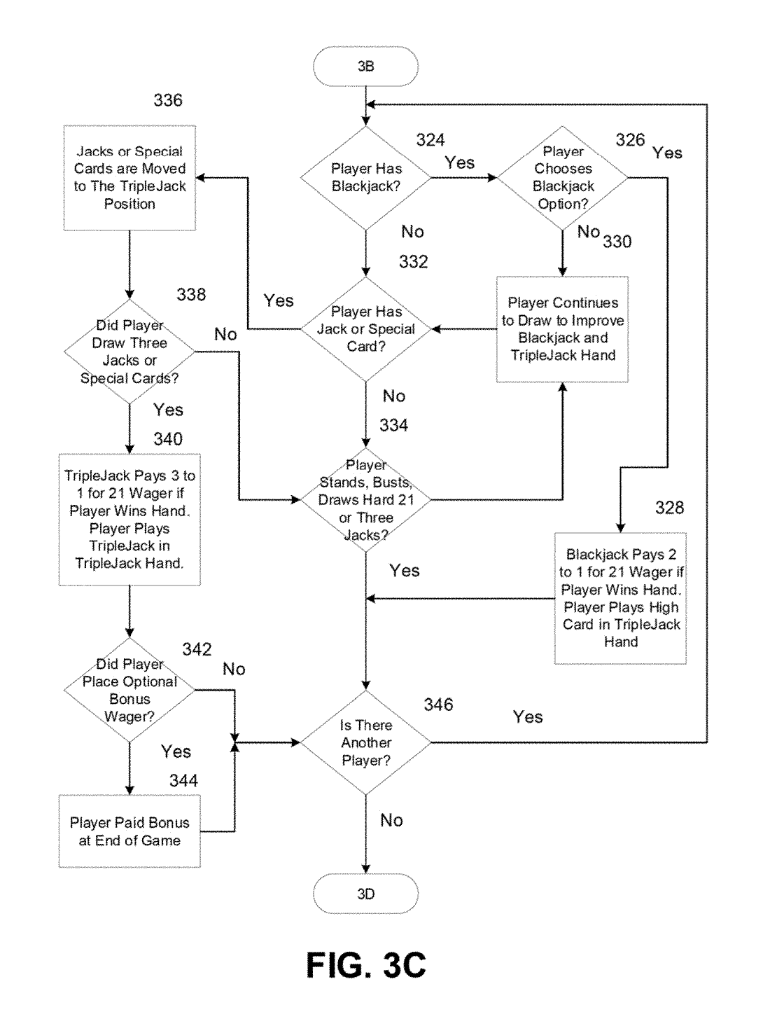

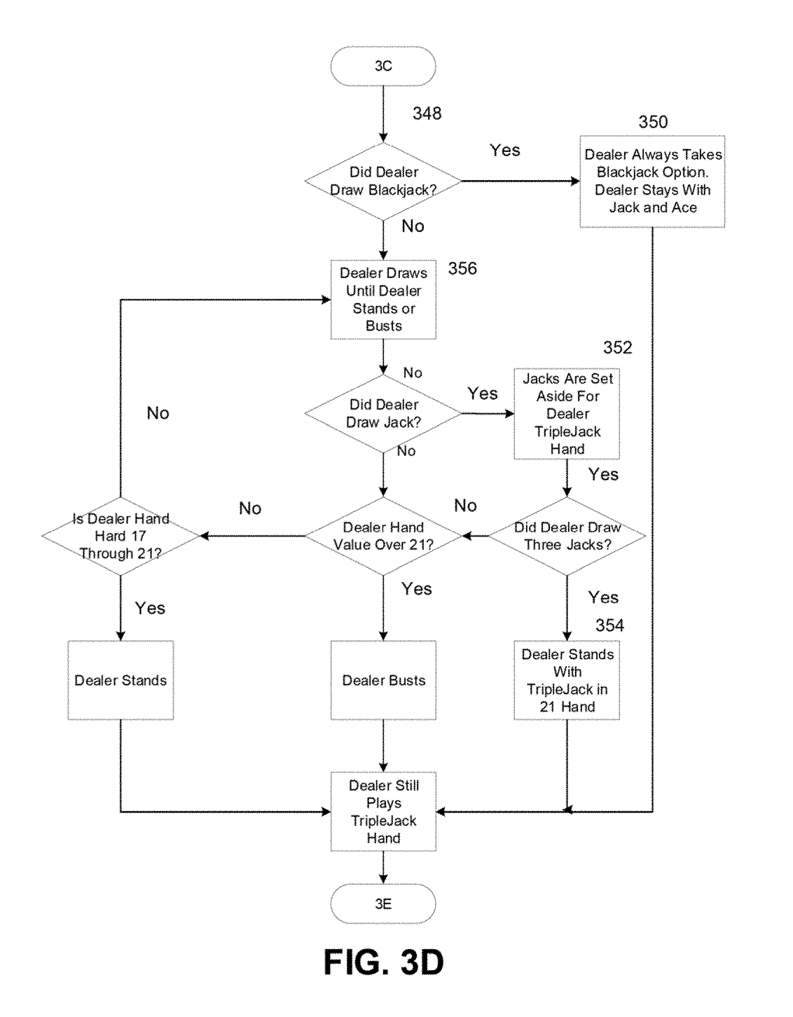

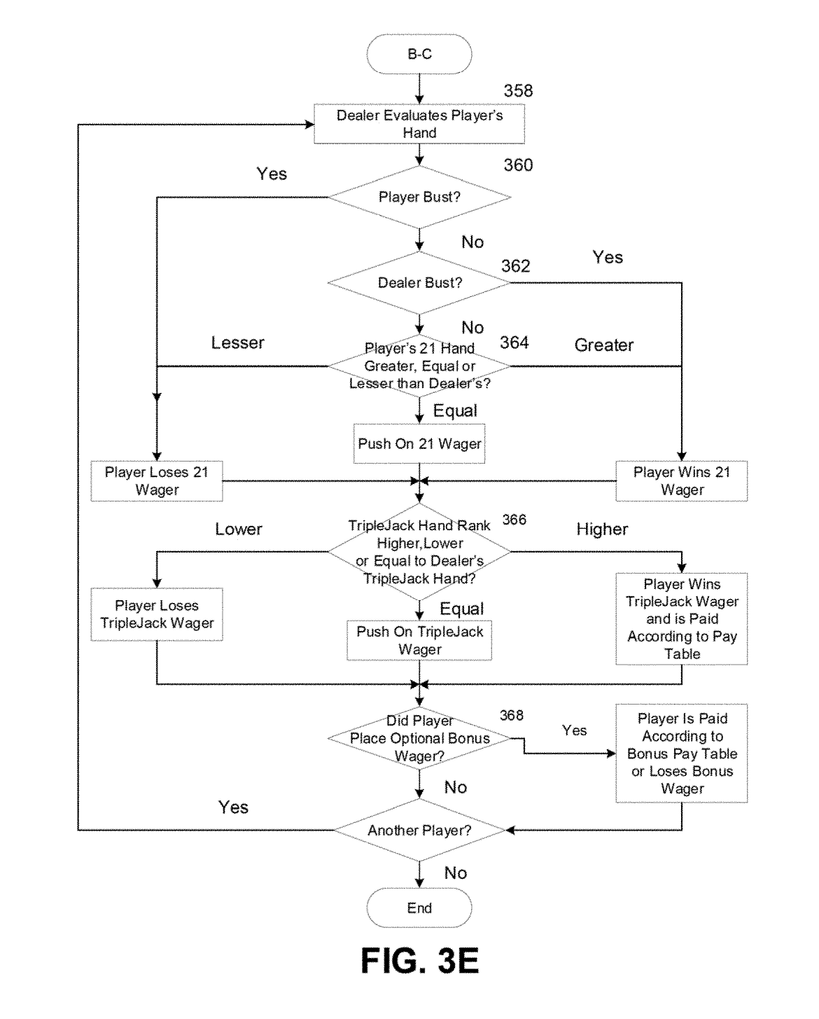

FIGS. 3A-3E illustrate a flow chart method for operation of the exemplary combination wagering game as described in accordance with an embodiment of the present invention. Such a method is capable of being implemented across a wide variety of forms and media including, but not limited to, a card came played on a custom casino gaming surface, electronic gaming machines, single player video slot machines, multi-player video slot machines, electronic games and devices, lottery terminals, scratch-card formats, travel consoles, personal computers, smartphone and tablet applications, and home and interne gaming.

FIG. 3A illustrates a flow diagram of the overall process of playing a casino wagering game as described with reference to FIG. 3B, FIG. 3C, FIG. 3D and FIG. 3E in accordance with an embodiment of the invention. The process involves a method of playing a combination wagering game on a custom casino playing surface with at least one deck of standard playing cards with the number of decks changing the odds and payout outcomes for varying hands. The gameflow begins with each player making two wagers on an individual playing and wagering area (one wager a 21 wager, and the other a poker-type wager) 302. Each player then places an optional bonus wager as a side wager 304. A dealer deals at least two cards to each player (the first two cards being face up) 306. The dealer then deals his or herself two cards (one of the cards being face down) 308. Then, the games of 21, a poker-like game, and a bonus game are played 310. Finally, the wagers for each game according to basic or modified rules of blackjack, the modified rules of a poker-type game, and a specialized bonus game are resolved 312.

FIG. 3B illustrates the introductory steps of playing the exemplary combination wagering game. The exemplary combination wagering game requires each player to make two wagers 314 on an individual playing and wagering area as described in FIG. 1 and FIG. 2. One wager is a 21 wager, and the other is a poker-type wager, which may also be called the TripleJack wager. Additionally, an optional bonus wager feature is provided 316 for a player to place a side wager. The dealer then deals 318 two cards to each player, both cards being face up 320. The dealer is dealt two cards, one of the cards being face down 320. The game then proceeds with each player playing their respective hands 322.

FIG. 3C illustrates the player's turn of playing the exemplary combination wagering game. The first object of the combination wagering game is for a player to obtain a winning 21 hand. This may be accomplished drawing an ace and a jack, or an ace with a card with a numerical value of ten 324, known as a blackjack, or by drawing cards to obtain a hand with a value of 21 without going over or “busting.” In the preferred embodiment of the combination wagering game, when a player draws a jack, said jack is set aside. The jack is not counted towards the value of the player's blackjack hand. The jack can be, however, used in calculating the player's TripleJack hand. Furthermore, jacks set aside can be used to win additional payouts in the bonus or jackpot feature. Alternative embodiments of the present invention could include the use of other cards in lieu of jacks. In addition, certain cards, such as jacks, could feasibly be assigned a value of zero or ten, much akin to the dual value of aces in standard 21, to contribute to an already unique gaming experience.

If a player draws a blackjack hand 324 (i.e. an Ace plus a jack, or an ace with a card ranked ten or higher), then the player may exercise the option 326 of taking the blackjack hand which pays two to one 328, provided the dealer does not also have a blackjack hand or three jacks, and playing the poker hand with an ace as the player's high card. A player also has the option of foregoing the blackjack hand 330 to better the poker hand as well as attempting to win the bonus or jackpot feature by setting a jack aside 332 and drawing another card. Once a card is taken, the player forfeits their ‘blackjack option,’ and the hand is no longer considered a blackjack. In turn, the player will no longer receive 2 to 1 on the original winning blackjack hand.

If a player does not draw a blackjack hand, then the player has the option of drawing cards 332 to improve both the player's 21 hand and the player's poker hand. A player can draw cards until the player reaches a hand value of a hard twenty-one (21 with a combination of three or more cards), until the player “busts” by exceeding a hand value of twenty-one, until the player draws three jacks, or when the player determines he or she has a hand of significant value to play against the dealer 334. If a player “busts,” then the player loses their blackjack bet regardless of what the dealer draws. The “busted” hand remains on the playing surface, and is used to play the TripleJack hand against the dealer.

When a player draws a jack, it is placed to the side 336 of the playing space. A player has the chance to draw up to three jacks to complete a TripleJack hand 338 before drawing a hand with a numerical value of 21 or “busting.” Since jacks have no numerical value in calculating a blackjack hand, a player could technically, although the odds are mathematically small, draw jack after jack until player ultimately draws three suited jacks. When a player does draw three jacks, or a TripleJack, then the player's blackjack hand beats the dealer's blackjack or numerical 21, and is paid at 3 to 1 odds for the 21 wager 340. If a player makes the optional bonus or jackpot wager 342 and draws a hand that matches any of the winning hands on the jackpot or bonus pay table, then the player is paid accordingly 344. This optional bonus wager may be linked to a progressive jackpot or any other high paying feature. When a player is finished with determining their hand, the next player begins 346. The player does not have to win either the blackjack or TripleJack hands against the dealer to collect the payout bonus on the bonus wager.

After each player has completed their play, as illustrated in FIG. 3D, the dealer then plays his or her hand 348. First, the dealer turns over the down card to determine whether the dealer drew a blackjack hand or not. If the dealer draws a blackjack 350, then the dealer stands on that value regardless of whether a jack was in the dealer's hand. The dealer's hand is then compared against the players' hands. If a player is dealt a blackjack and the dealer is likewise dealt a blackjack, then the 21 wager is a push.

The dealer also has the chance to draw three jacks as well. Just as with the player, jacks have no 21 hand value, and are set aside 352 for the dealer's TripleJack hand. If the dealer draws three jacks 354, then the dealer stands with a TripleJack for a 21 hand and TripleJack for the TripleJack hand. The dealer can continue drawing cards 356 until the dealer draws three jacks, the dealer draws a numerical hand value between hard 17 and 21, or the dealer “busts” by exceeding a numerical value of 21. As with the player, a hand containing three jacks is known as a TripleJack, and is a higher ranked hand than blackjack with regards to the blackjack wager.

At this point as illustrated in FIG. 3E, hands are now compared. When the player “busts,” 360 the player loses the 21 hand wager, and the player's TripleJack hand is later compared to the dealer's. When the dealer “busts,” 362 and the player has a 21 hand with a numerical value of 21 or less, then the player wins the 21 wager. Additionally, if the player has a higher numerical valued hand without exceeding 21 than the dealer, then the player wins the 21 wager. If both player and dealer ultimately draw equal numerical 21 hand values, then the 21 hand is a push.

The player's TripleJack hand is then compared to the dealer's 366. If the dealer has a higher ranked poker value hand based on the best of up to three cards as provided for in the casino's hand ranks, then the dealer wins the TripleJack hand, and the player loses his or her TripleJack wager. Alternative embodiments of the invention may include a poker-like hand consisting of more or less than three cards which may be played against the dealer's hand. Conversely, if the player ultimately has a higher ranked hand based on up to three cards, then the player wins the TripleJack wager, and is paid according to the payout table. Lastly, if a player placed the optional bonus wager, 368 the player is paid according to the bonus wager pay table.

At this point, the game is completed. Players can then exercise the option to play again or cash out.

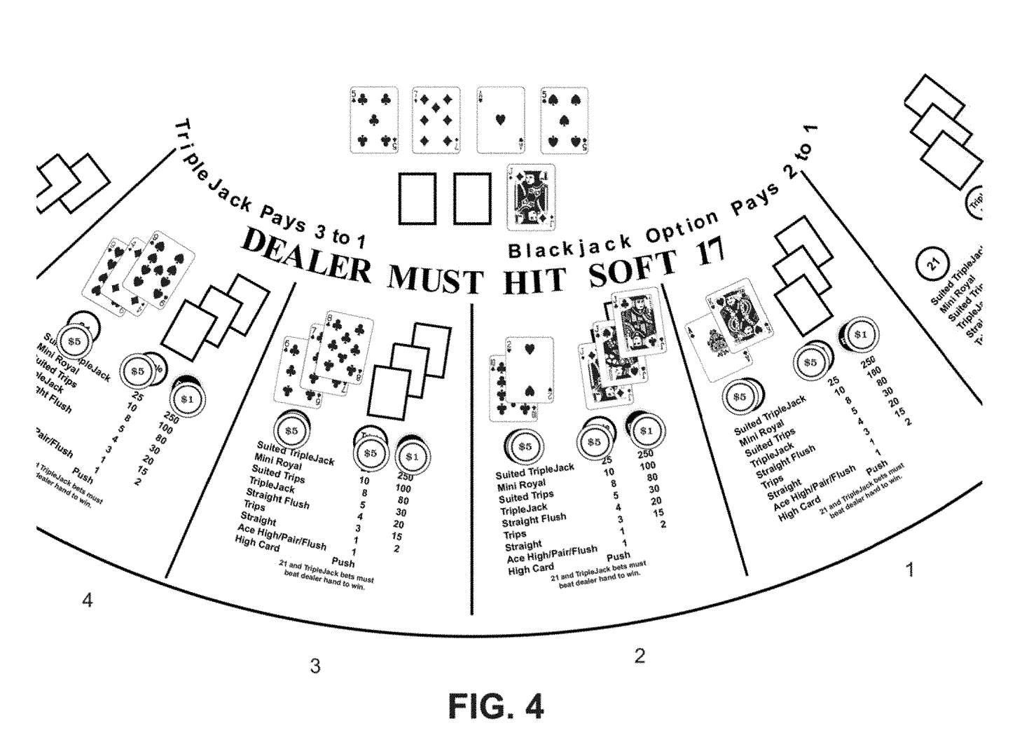

FIG. 4 illustrates a view of an exemplary playing and wagering surface or layout with player and dealers cards shown as example hands. In accordance with the rules of the preferred embodiment of the invention, four players, numbered 1, 2, 3, and 4 played hands against the dealer. Each player wagered $5 for the 21 hand and TripleJack hand, and wagered $1 for the bonus option. As depicted, each player and the dealer drew cards, completed their hands, and are now comparing their respective hands to determine payouts.

Player 1, in this instance, drew a natural blackjack. Player 1 chose the blackjack option, which is to stand on the natural 21 and not attempt to improve his or her TripleJack hand. In this instance, Player 1 would be paid 2 to 1 odds for the blackjack draw. However, as will be explained below, Player 1 only has an ace high hand to play in the TripleJack phase of the game. The dealer, in this instance, drew an 18 for his or her 21 hand, but drew a pair of fives with an ace kicker to play in the TripleJack hand. Thus, Player 1 won $10 for the blackjack hand and lost $5 for the TripleJack hand. Furthermore, Player 1 had no hand that ranked high enough on the bonus wager pay table, so player 1 lost the $1 bonus wager.

Player 2 initially drew the ten of clubs and the jack of diamonds. The jack was set aside and Player 2 drew a jack of spades, which was also set aside. Player 2 then drew the two of hearts. In an effort to better his or her hand, player 2 then chose to draw another card. That final card was the jack of clubs. Player 2 now has a TripleJack. In this instance, Player 2 wins the 21 hand because TripleJack is ranked higher, and is paid 3 to 1 for the 21 wager. Player 2 also wins the TripleJack hand against the dealer's pair of fives. Therefore, according to the pay table of the preferred embodiment, Player 2 is paid 3 to 1 for the 21 wager, 5 to 1 for the TripleJack wager and 30 to 1 for optional the bonus wager.

Player 3 originally drew the six of clubs and the seven of clubs, and then drew the eight of clubs in an attempt to better both his or her 21 hand and TripleJack hand. Player 3 ended up drawing not only a 21 for his or her 21 hand, but also drew a straight flush for his or her TripleJack hand. Therefore, according to the pay table in the preferred embodiment, Player 3 would be paid even odds (1 to 1) for the 21 wager, 4 to 1 for the $5 TripleJack wager and 20 to 1 for the $1 optional bonus wager.

Player 4 originally drew the nine of hearts and the four of diamonds, and then drew the nine of spades in an attempt to better both his or her 21 hand and TripleJack hand. In this instance, Player 4's drawing of the extra nine resulted in a bust on player 1's 21 hand with a hand value of 22, thus resulting in a loss of the 21 wager. However, Player 4 drew a pair of nines to play against the dealer in the TripleJack hand. Because player 4's pair of nines ranked higher than the dealer's pair of fives, Player 4 won the TripleJack wager. And because a pair does not rank in the bonus wager table, Player 4 lost the bonus wager.

The dealer originally drew an ace up and the five of spades down. Unlike traditional 21, players are not given the option to buy “insurance” when the dealer shows an ace on his or her original hand. When the dealer turned over the five of spades, the dealer drew the jack of diamonds, which was set aside for a TripleJack hand and not counted towards the dealer's 21 hand. The dealer then drew the seven of diamonds which made the dealer play the ace as a card with a numerical rank of 1 instead of 11. The dealer then drew the five of diamonds and stood on the 21 hand with a numerical value of 18, which only beat Player 4 in the 21 hand. The dealer only had a pair of fives to play against the four players in the TripleJack hand.

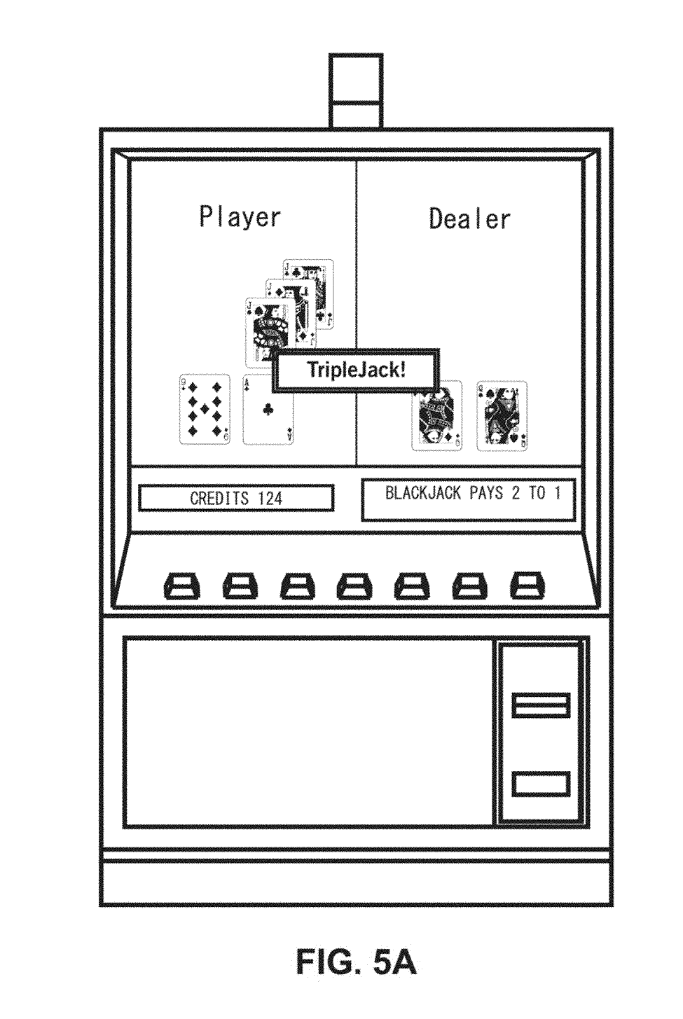

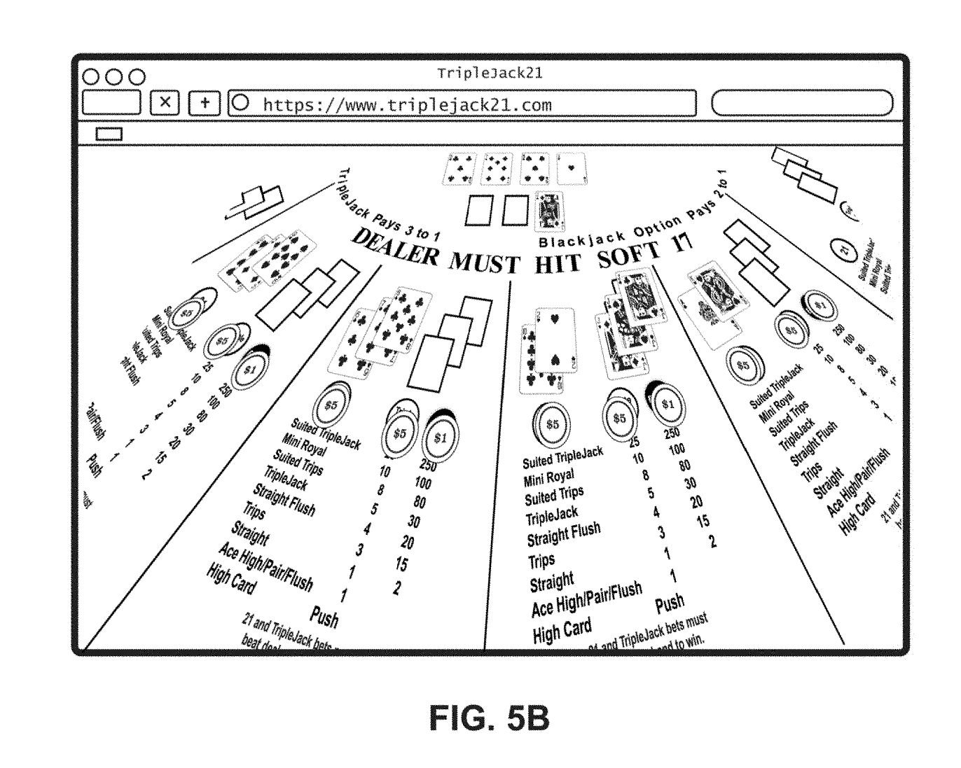

FIG. 5A illustrates a perspective view of an Electronic Gaming Machine employing a combination wagering game in accordance with an embodiment of the invention. Persons skilled in the art will readily appreciate that such an EGM is used by casinos and gaming establishments, and that the exemplary combination wagering game is capable of being implemented in such a device. It will further become apparent to persons having skill in the art that the EGM as described in FIG. 5A may be but one of many video gaming machine variants used in casinos, arcades, for home and/or personal use, and other entertainment establishments.

FIG. 5B illustrates a screen display of a casino wagering game in accordance with an embodiment of the invention. In this view, the Electronic Gaming Machine used is a networked personal computer with the exemplary combination wagering game being played over a global network such as the Internet or World Wide Web. Persons skilled in the art will readily appreciate that such a system is used in, but is not limited specifically to, personal computers, tablets, PDAs, smartphones, and wearable technologies. Persons skilled in the art will readily appreciate that wagering may be performed through conventional online banking techniques or may be made with cryptocurrency according to cryptocurrency protocols and recorded in a blockchain. It will further become apparent to persons having skill in the art that the exemplary display as described in FIG. 5B may be but one of many embodiments used in implementing the exemplary combination wagering game.

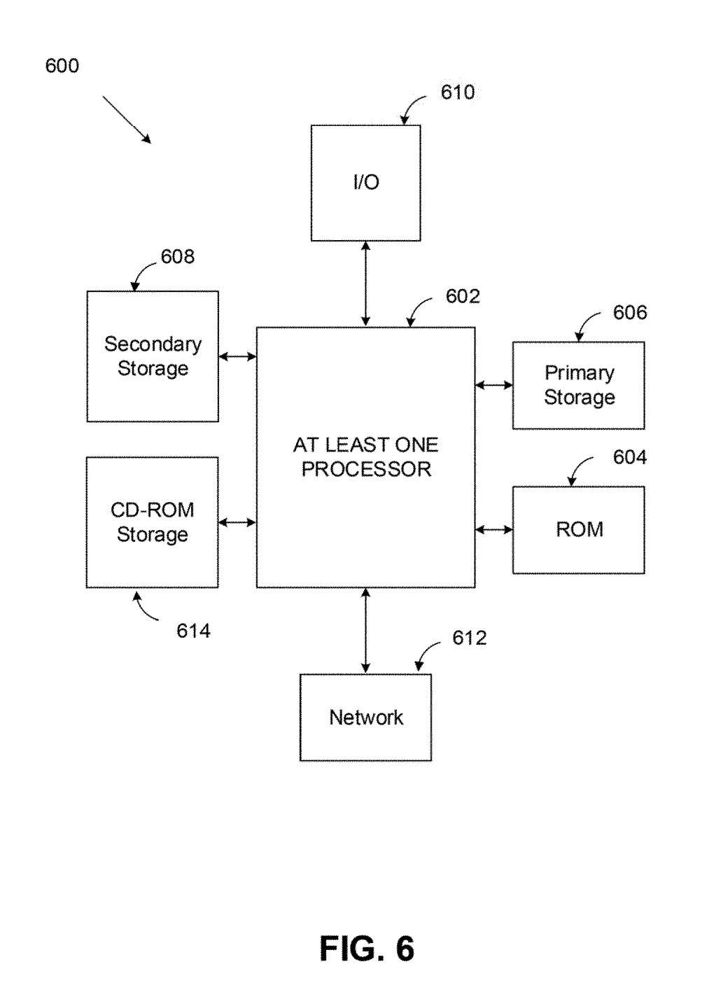

FIG. 6 illustrates a computer system that, when appropriately configured or designed, may serve as a computer system, or Electronic Gaming Machine (EGM), 700 for which the combination wagering game may be embodied.

A computer system or EGM 600 includes at least one, or a quantity of processors 602 (also referred to as central processing units, or CPUs) that may be coupled to at least one storage or memory devices including a primary storage 606 (typically a random access memory, or RAM), a primary storage 604 (typically a read-only memory, or ROM). A CPU 702 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors. As is well known in the art, a computer system's primary storage 604 acts to transfer data and instructions unidirectionally to the CPU and primary storage 606 typically may be used to transfer data and instructions in a bi-directional manner. The primary storage devices discussed previously may include any suitable computer-readable media such as those described above. A mass storage device 608 may also be coupled bidirectionally to CPU 602, which provides additional data storage capacity and may include any of the computer-readable media described above. Such mass storage devices 608, such as hard drives, may be used to store programs, data and the like and may typically be used as a secondary storage medium. Persons skilled in the art will readily understand that the information retained within mass storage device 608, may, in appropriate cases, be incorporated in standard fashion as part of primary storage 606 as virtual memory. A specific mass storage device such as, but not limited to, a CD-ROM 614 may also pass data uni-directionally to the CPU.

In various embodiments of the present invention, at least one memory device of the computer system or EGM, generally the primary storage 606, includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the EGM includes flash memory and/or EEPROM (electrically erasable programmable read only memory). Persons skilled in the art will understand that any other suitable magnetic, optical, and/or semiconductor memory may operate in conjunction with the computer system or EGM disclosed herein. In certain embodiments, the at least one processor of the computer system or EGM and the at least one memory device of the computer system or EGM both reside within a cabinet of typical casino EGM (as described in FIG. 5A above).

In certain embodiments, as generally described above, the at least one memory device of the EGM stores program code and instructions executable by the at least one processor of the EGM to control the EGM. The at least one memory device of the EGM also stores other operating data, such as image data, event data, input data, random number generators (RNGs) or pseudo-RNGs, pay table data or information, and/or applicable game rules that relate to the play of at least one or more games on the EGM (such as primary or base games and/or secondary or bonus games as described below). In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present invention. In other embodiments, part or all of the program code and/or the operating data may be downloaded to the at least one memory device of the EGM through any suitable data network described above.

The CPU 602 may also be coupled to an interface 610 that connects to one or more input/output devices such as such as video monitors, push buttons, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

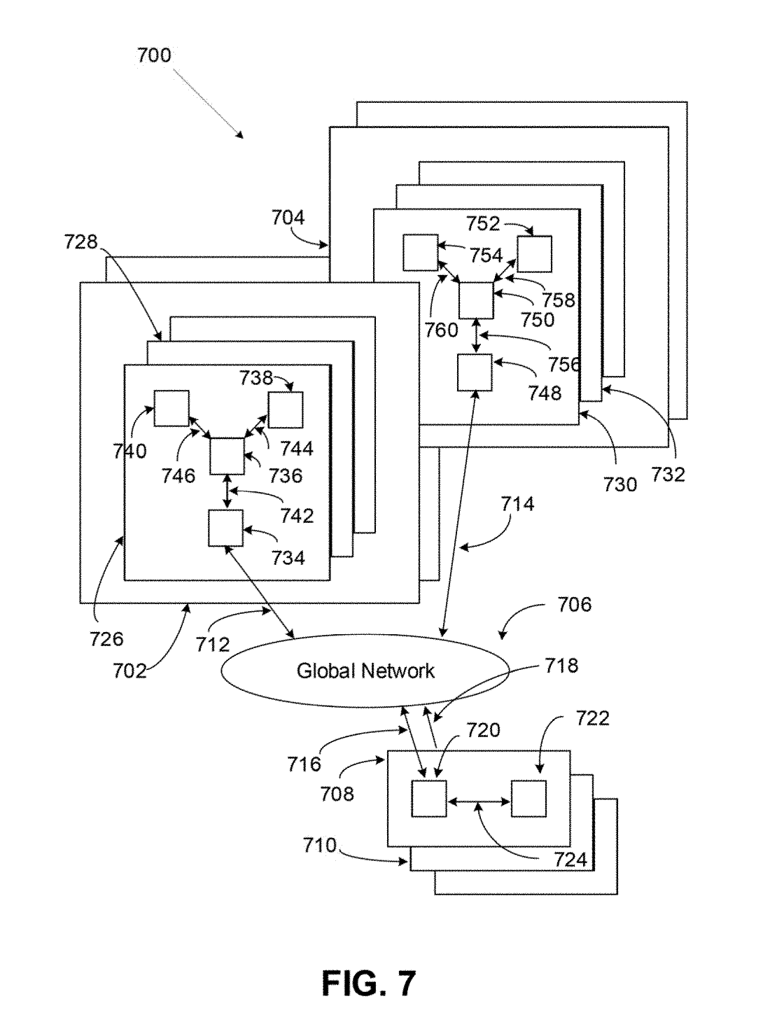

FIG. 7 is a block diagram depicting an exemplary client/server system which may be used by an exemplary web-enabled/networked embodiment of the present invention.

A communication system 700 includes a plurality of regions with a sampling of regions denoted as a network region 702 and a network region 704, a global network 706 and one or more servers with a sampling of servers denoted as a server device 708 and a server device 710.

Network region 702 and network region 704 may operate to represent a network contained within a geographical area or region. Non-limiting examples of representations for the geographical areas for the networked regions may include postal zip codes, telephone area codes, states, counties, cities and countries. Elements within network region 702 and 704 may operate to communicate with external elements within other networked regions or within elements contained within the same network region.

In some implementations, the global network 706 may operate as the Internet or the World Wide Web. It will be understood by those skilled in the art that such a communication system 700 may take many different forms. Non-limiting examples of forms for communication system 700 include local area networks (LANs), wide area networks (WANs), peer-to-peer (P2P) networks, wired telephone networks, cellular telephone networks or any other network supporting data communication between respective entities via hardwired or wireless communication networks. The global network 706 may operate to transfer information between the various networked elements.

Server device 708 and server device 710 may operate to execute software instructions, store information, support database operations and communicate with other networked elements. Non-limiting examples of software and scripting languages which may be executed on server device 708 and server device 710 include C, C++, C#, Python, PHP, SQL, JavaScript, and Swift.

Network region 702 may operate to communicate bi-directionally with global network 706 via a communication channel 712. Network region 704 may operate to communicate bi-directionally with global network 706 via a communication channel 714. Server device 708 may operate to communicate bi-directionally with global network 706 via a communication channel 716. Server device 710 may operate to communicate bi-directionally with global network 706 via a communication channel 718. Network region 702 and 704, global network 706 and server devices 708 and 710 may operate to communicate bi-directionally and also communicate bi-directionally with other networked device located within communication system 700.

Server device 708 includes a networking device 720 and a server 722. Networking device 720 may operate to communicate bi-directionally with global network 706 via communication channel 716 and with server 722 via a communication channel 724. Server 722 may operate to execute software instructions and store information.

Network region 702 includes a multiplicity of clients with a sampling denoted as a client 726 and a client 728. Client 726 includes a networking device 734, a processor 736, a Graphical User Interface (GUI) 738 and an interface device 740. Non-limiting examples of devices for GUI 738 include electronic gaming machines (EGMs), monitors, televisions, cellular telephones, smartphones and PDAs (Personal Digital Assistants). Non-limiting examples of interface devices 740 include buttons, pointing device, mouse, trackball, scanner and printer. Networking device 734 may communicate bi-directionally with global network 706 via communication channel 712 and with processor 736 via a communication channel 742. GUI 738 may receive information from processor 736 via a communication channel 744 for presentation to a user for viewing. Interface device 740 may operate to send control information to processor 736 and to receive information from processor 736 via a communication channel 746. Network region 704 includes a multiplicity of clients with a sampling denoted as a client 730 and a client 732. Client 730 includes a networking device 748, a processor 750, a GUI 752 and an interface device 754. Non-limiting examples of devices for GUI 738 include electronic gaming machines (EGMs), monitors, televisions, cellular telephones, smartphones and PDAs (Personal Digital Assistants). Non-limiting examples of interface device 740 include pointing devices, mousse, trackballs, scanners and printers. Networking device 748 may communicate bi-directionally with global network 706 via communication channel 414 and with processor 750 via a communication channel 756. GUI 752 may receive information from processor 750 via a communication channel 758 for presentation to a user for viewing. Interface device 754 may operate to send control information to processor 750 and to receive information from processor 750 via a communication channel 760.

For example, consider the case where a user interfacing with client 726 may want to execute a networked application such as the exemplary combination wagering game. A user may enter the web address or IP (Internet Protocol) address for the networked application using interface device 740. The IP address information may be communicated to processor 736 via communication channel 746. Processor 736 may then communicate the IP address information to networking device 734 via communication channel 742. Networking device 734 may then communicate the IP address information to global network 706 via communication channel 712. Global network 706 may then communicate the IP address information to networking device 420 of server device 708 via communication channel 716. Networking device 720 may then communicate the IP address information to server 722 via communication channel 724. Server 722 may receive the IP address information and after processing the IP address information may communicate return information to networking device 720 via communication channel 724. Networking device 720 may communicate the return information to global network 706 via communication channel 716. Global network 706 may communicate the return information to networking device 734 via communication channel 712. Networking device 734 may communicate the return information to processor 736 via communication channel 742. Processor 736 may communicate the return information to GUI 738 via communication channel 744. User may then view the return information on GUI 738.

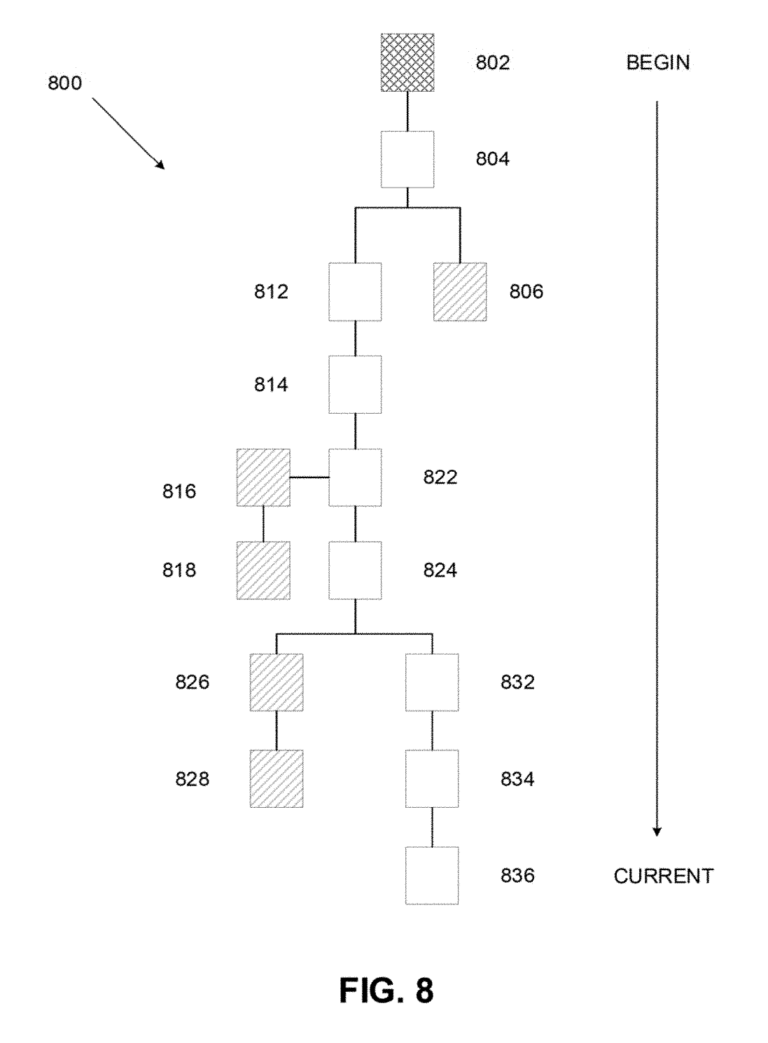

FIG. 8 is a diagram illustrating a simple blockchain. Blocks in the main chain 802, 804, 812, 814, 822, 824, 832, 834, 836 are the longest series of blocks that go from the beginning block 802 to the current block 836. For any block in the blockchain, there is only one path from the beginning block 802 to the current block 836. Blocks 806, 816, 818, 826, 828 are blocks that are not in the longest chain. Because this is a distributed system, blocks 816, 818, 826, 828 are typically created only a few seconds apart from the main chain. Whenever a fork happens, generating computing nodes builds onto which ever block is received first in time. Therefore, the short chain of blocks 116, 118, 126, 128 are not used.

In another example, each user of the blockchain in FIG. 1 is a member or subscriber. Only after a set number of members or subscribers vote on the addition of a new block in the block chain, is a block chain added. In this member-based system, the short chains of block 116, 118, 126, 128 are not created.

The blockchain 100 implementation consists of two kinds of records-transactions and blocks. Transactions are the actual data stored in the blockchain. As shown the data in each of the blockchain is encrypted as shown graphically by the lock. In one example, the data in each block represents a single transaction. In another example, data in each block represents more than on transaction that is dividable into sections within each block, such as, the wager of a single hand from a gaming session or an image in series of images. Transactions are created by users or participants using the system. The blocks are recorded to confirm when and in what sequence a certain transaction become journaled as part of the blockchain database.

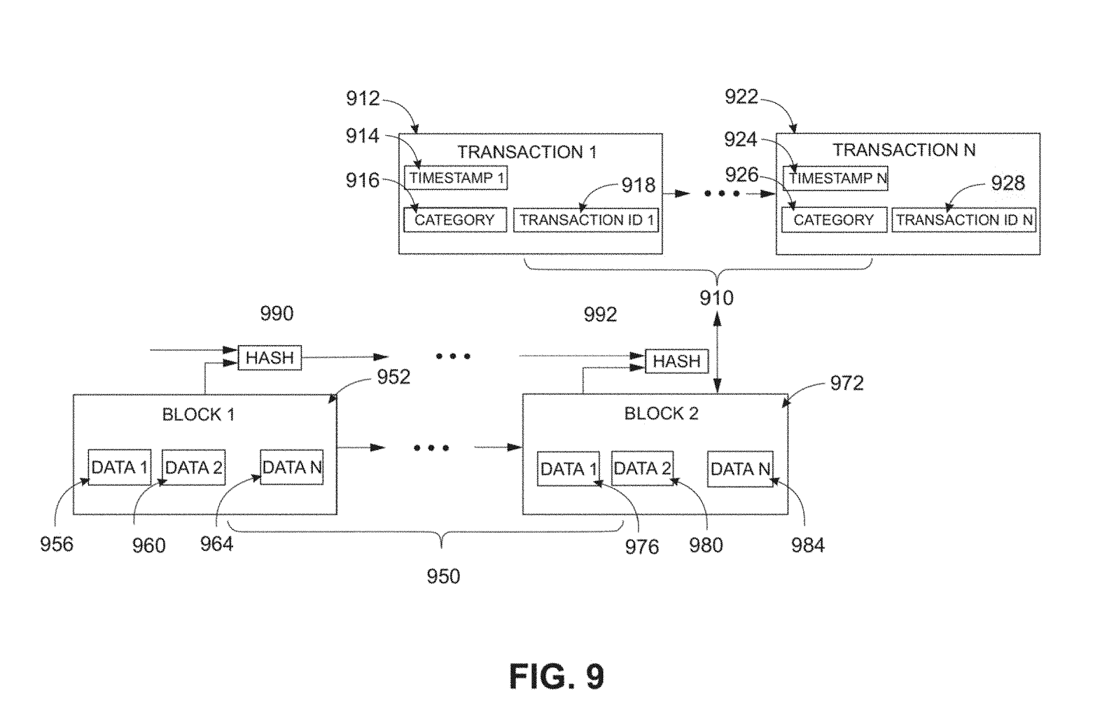

FIG. 9 is a functional diagram 900 illustrating details of each block and transaction in the blockchain of FIG. 8. Shown are two kinds of record blocks 910 and transactions 950. The transactions 950 are actual data stored in the blockchain 900. The blocks 910 are records of transactions. In this example transactions 910 are all associated with block 2 972. Other transactions (not shown are associated with block 1 952).

Record blocks 910 represent a series of transactions 912 through 912 as shown for transactions 1 through transaction n respectively. Each block 910 representing a transaction typically includes a timestamp 914, 924 of the transaction. A unique transaction identifier 918, 928 is also shown. This transaction id can be search for a specific item in the transactional database management system. Also shown is an optional category for the transaction 916, such as wager, marker, financial, employment, etc. to associate with the additional data in the transactions 950 described below.

A hash function 990 and 992 is shown as part of the record blocks 910. In one implementation of a blockchain, the previously hash function 990 is input to a subsequent hash function 992, along with the transaction 1 as shown. This ensures that there has been no tampering or alteration of the data in the record blockchain.

Transactions 950 shown in block 1 through block N, (952, 972) contain user or additional data 956, 960, 964, 976, 980, 984. The additional data can represent any multimedia data including text, audio, video, images, financial statements, and more.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the combination wagering game, other equivalent or alternative methods of implementing the combination wagering game according to the present invention will be apparent to those skilled in the art. Various aspects of the combination wagering game have been described above by way of illustration, and the specific embodiments disclosed are not intended to limit the invention to the particular forms disclosed. The particular implementation of the combination wagering game may vary depending upon the particular context or application. By way of example, and not limitation, the combination wagering game described in the foregoing was principally directed to casino table game variations, gaming machine variations and internet gaming systems. However, similar techniques may instead be applied to other computer-implemented and network platforms which implementations of the present invention are contemplated as within the scope of the present invention. Additionally, differing card numbers, appearances and values may be employed to create differing hand ranks and payouts. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Although specific features of the combination wagering game are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively, and are not limited to any physical interconnection. Claim elements and steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A method of playing a combination wagering game on a custom casino playing and wagering surface with at least one deck of standard playing cards comprising the steps of:
a) Each player making two wagers on an individual playing and wagering area, one wager a 21 wager, and the other a poker-type wager;
b) Each player placing an optional bonus wager as a side wager;
c) A dealer dealing at least two cards to each player, the first two cards being face up;
d) The dealer dealing his or herself two cards, one of the cards being face down;
e) Playing the games of 21, a poker-like game, and a bonus game; and
Resolving the wagers for each game according to basic or modified rules of blackjack, poker and a specialized bonus game.

2. The method of claim 1 wherein the players attempt to obtain a winning 21 hand by drawing an ace and a jack, or an ace with a card with a numerical value of ten, known as a blackjack, or by drawing cards to obtain a hand with a value of 21 without going over or “busting,” while contemporaneously attempting to obtain a winning poker-type hand without going over 21 or “busting.”

3. The method of claim 1 wherein the players contemporaneously attempt to obtain a bonus hand, where if a player draws a jack or any specific card, said jack or any specific card is set aside and is not counted towards the value of the player's 21 hand and can be used in calculating the player's poker-type hand without going over 21 or “busting.”

4. The method of claim 1 wherein the players, upon drawing a blackjack hand, may exercise the option of taking the 21-hand win, which pays a set amount provided the dealer does not also have a blackjack hand or three jacks or three specific cards, or continuing to improve the player's poker-type hand with an ace as the player's high card while also attempting to better the bonus game hand by drawing for three jacks or three other specific cards without going over a numerical hand value of 21 or “busting.”

5. The method of claim 1 wherein a player's turn ends upon the player standing on a 21 hand, standing on a poker hand, standing on a bonus hand win or going over a numerical hand value or “busting.”

6. The method of claim 1 wherein the dealer, after each player has completed their play, plays his or her hand first by turning over the down card to determine whether the dealer wins the 21 hand by drawing a blackjack, then stands on that value regardless of whether a jack was in the dealer's hand, or playing the dealer's 21 hand, poker-type hand and bonus hand; otherwise the dealer continues to play his or her hand by attempting to obtain a hand with a value of 21 without going over or “busting” while contemporaneously attempting to obtain a winning poker-type hand or bonus hand without going over 21 or “busting.”

7. The method of claim 1 where the optional bonus wager is linked to a jackpot or progressive jackpot.

8. A method of playing a combination wagering game on a single or multiplayer casino electronic gaming machine with at least one deck of virtual playing cards comprising the steps of:
a) Each player placing an optional bonus wager as a side wager;
b) A processor dealer dealing at least two cards to each player, the first two cards being face up;
c) The processor dealer dealing his or herself two cards, one of the cards being face down;
d) Playing the games of 21, a poker-like game, and a bonus game; and
e) Resolving the wagers for each game according to basic or modified rules of blackjack, poker and a specialized bonus game through a computer implemented means.

9. The method of claim 7 wherein the players attempt to obtain a winning 21 hand by drawing an ace and a jack, or an ace with a card with a numerical value of ten, known as a blackjack, or by drawing cards to obtain a hand with a value of 21 without going over or “busting,” while contemporaneously attempting to obtain a winning poker-type hand without going over 21 or “busting.”

10. The method of claim 7 wherein the players contemporaneously attempt to obtain a bonus hand, where if a player draws a jack or any specific card, said jack or any specific card is set aside and is not counted towards the value of the player's 21 hand and can be used in calculating the player's poker-type hand without going over 21 or “busting.”

11. The method of claim 7 wherein the players, upon drawing a blackjack hand, may exercise the option of taking the 21-hand win, which pays a set amount provided the dealer does not also have a blackjack hand or three jacks or three specific cards, or continuing to improve the player's poker-type hand with an ace as the player's high card while also attempting to better the bonus game hand by drawing for three jacks or three other specific cards without going over a numerical hand value of 21 or “busting.”

12. The method of claim 7 wherein a player's turn ends upon the player standing on a 21 hand, standing on a poker hand, standing on a bonus hand win or going over a numerical hand value or “busting.”

13. The method of claim 7 wherein the processor dealer, after each player has completed their play, plays its hand first by turning over the down card to determine whether the dealer wins the 21 hand by drawing a blackjack, then stands on that value regardless of whether a jack was in the dealer's hand, or playing the dealer's 21 hand, poker-type hand and bonus hand; otherwise the dealer continues to play his or her hand by attempting to obtain a hand with a value of 21 without going over or “busting” while contemporaneously attempting to obtain a winning poker-type hand or bonus hand without going over 21 or “busting.”

14. The method of claim 8 wherein the optional bonus wager is linked to a jackpot or progressive jackpot.

15. A method of playing a combination wagering game on a single or multiplayer networked electronic gaming machine with at least one deck of virtual playing cards comprising the steps of:
a) Each player making two wagers on a virtual playing and wagering area, one wager a 21 wager, and the other a poker-type wager;
b) Each player placing an optional bonus wager as a side wager;
c) A processor dealer dealing at least two cards to each player, the first two cards being face up;
d) The processor dealer dealing his or herself two cards, one of the cards being face down;
e) Playing the games of 21, a poker-like game, and a bonus game; and
Resolving the wagers for each game according to basic or modified rules of blackjack, poker and a specialized bonus game through a computer implemented means.

16. The method of claim 13 wherein the players attempt to obtain a winning 21 hand by drawing an ace and a jack, or an ace with a card with a numerical value of ten, known as a blackjack, or by drawing cards to obtain a hand with a value of 21 without going over or “busting,” while contemporaneously attempting to obtain a winning poker-type hand without going over 21 or “busting.”

17. The method of claim 13 wherein the players contemporaneously attempt to obtain a bonus hand, where if a player draws a jack or any specific card, said jack or any specific card is set aside and is not counted towards the value of the player's 21 hand and can be used in calculating the player's poker-type hand without going over 21 or “busting.”

18. The method of claim 13 wherein the players, upon drawing a blackjack hand, may exercise the option of taking the 21-hand win, which pays a set amount provided the dealer does not also have a blackjack hand or three jacks or three specific cards, or continuing to improve the player's poker-type hand with an ace as the player's high card while also attempting to better the bonus game hand by drawing for three jacks or three other specific cards without going over a numerical hand value of 21 or “busting.”

19. The method of claim 13 wherein a player's turn ends upon the player standing on a 21 hand, standing on a poker hand, standing on a bonus hand win or going over a numerical hand value or “busting.”

20. The method of claim 13 wherein the processor dealer, after each player has completed their play, after each player has completed their play, plays its hand first by turning over the down card to determine whether the dealer wins the 21 hand by drawing a blackjack, then stands on that value regardless of whether a jack was in the dealer's hand, or playing the dealer's 21 hand, poker-type hand and bonus hand; otherwise the dealer continues to play his or her hand by attempting to obtain a hand with a value of 21 without going over or “busting” while contemporaneously attempting to obtain a winning poker-type hand or bonus hand without going over 21 or “busting.”

21. The method of claim 15 wherein the optional bonus wager is linked to a jackpot or progressive jackpot.

22. The method of claim 13 wherein the wager may be made with cryptocurrency according to cryptocurrency protocols and recorded in a blockchain.
